(19) United States
(12) Patent Application Publication
(10) Pub. No.: US 2025/0033570 A1
(43) Pub. Date: Jan. 30, 2025

(54) SECURE CUSHIONING CARGO BAG

(71) Applicant: SEASUCKER, LLC, Sarasota, FL (US)

(72) Inventors: Charles L. CASAGRANDE, Bradenton, FL (US); Christopher BARRS, Tampa, FL (US)

(21) Appl. No.: 18/706,786

(22) PCT Filed: Nov. 2, 2022
(86) PCT No.: PCT/US2022/048706

§ 371 Date: May 2, 2024

Related U.S. Application Data
(60) Provisional application No. 63/274,727, filed on Nov. 2, 2021.

(51) Int. Cl. B60R 9/055; A45C 13/02; B60R 9/058

(52) U.S. Cl. CPC B60R 9/055; A45C 13/021; B60R 9/058

(57) ABSTRACT

A collapsible and expandable weather-resistant cargo bag includes a bag portion, a cushioning portion, and an attachment feature. The bag portion is constructed a weather-resistant material and adapted and configured contain contents and allow for storage and removal of contents through a closable opening. The cushioning portion is coupled to the bag portion and is expandable and collapsible as well as adapted and configured to protect a substrate by being positioned between the substrate on which the cargo bag is placed and the contents stored in the bag portion. The attachment feature extends from one or more of the bag portion or the cushioning portion and is adapted and configured to allow for attachment of the cargo bag to a substrate.

### CROSS-REFERENCE TO RELATED APPLICATIONS

This application claims the benefit of U.S. Provisional Patent Application No. 63/274,727 filed on Nov. 2, 2021, which is herein incorporated by reference.

### CROSS-REFERENCE TO RELATED APPLICATIONS

Not Applicable.

### STATEMENT REGARDING FEDERALLY SPONSORED RESEARCH

Not Applicable.

### BACKGROUND

Cargo bags are currently used for a variety of cargo stowing applications. One such typical application is to stow cargo on the roof a vehicle. Existing cargo bags have a variety of shortcomings. Existing cargo bags are typically just bags that are strapped down. The straps are often passed through the window of the vehicle for attaching. Alternatively, the straps are tied to a luggage rack or other feature. In such cases the straps do not hold the leading edge of the bag down (the straps attaching the bag transversely not longitudinally to the vehicle) and the lifting of the bag from the air and the flapping straps can damage the car. The noise of straps in the wind during travel also creates a repetitive and annoying sound for the vehicle occupants. In addition, the contents of the bag can dent or damage the rooftop as there is only a small amount of material (e.g., plastic or canvas sheeting) between the bag and the roof it is sitting on. A heavy bag can very easily dent the roof.

Given the shortcomings of existing cargo bags, what is needed is a cargo bag that is a packable, travel ready, cargo bag for the roofs of vehicles that will not scratch, dent, crease, or damage the rooftop of a vehicle to which the cargo bag is attached. What is also needed is a cargo bag that can be packed into a bag easily and checked in as luggage. Once arriving to a destination and obtaining a rental car or other vehicle, the bag can be attached to the roof to hold luggage, supplies, or other cargo. What is further needed is a cargo bag that is usable in other applications than just as vehicle rooftop storage.

### BRIEF SUMMARY

Briefly, cargo bags and attachment systems, method of use, and method of manufacture are disclosed. The disclosed cargo bags and attachment systems provide several advantages. The cargo bag includes an inflatable or cushioning portion which forms part of the bottom of the cargo bag when the cargo bag is attached to or positioned on a substrate such as a vehicle roof. The inflatable portion or cushioning portion protects the substrate (e.g., vehicle roof) by distributing the load of the cargo in the cargo pad across at least a portion of the inflatable portion or cushioning portion of the cargo bag. This prevents damage to the substrate due to point loads of the cargo (e.g., due to the geometry of the cargo). In embodiments having an inflatable portion, the inflatable portion can be deflated when the cargo bag is not being used to allow for the cargo bag to be collapsed, folded, rolled, or otherwise reduced in size. This allows for the cargo bag to be compactly stowed when not in use.

The cargo bag further includes attachment features that allow for securing of the cargo bag to a substrate (e.g., a vehicle roof or other vehicle portion) without the use of length straps. For example, and as discussed in greater detail herein, a keder rail is included on the cargo bag which is held by a corresponding attachment device which can be releasably vacuum mounted to a vehicle roof. This eliminates the use of straps which can cause noise and damage to the vehicle.

Other advantages and features of the cargo bags and attachment systems are described herein, as well as additional detail, with respect to the figures and detailed description.

In one aspect, a collapsible and expandable weather-resistant cargo bag includes: a bag portion constructed a weather-resistant material and adapted and configured contain contents and allow for storage and removal of contents through a closable opening; a cushioning portion coupled to the bag portion, the cushioning portion being expandable and collapsible, the cushioning portion adapted and configured to protect a substrate by being positioned between the substrate on which the cargo bag is placed and the contents stored in the bag portion; and an attachment feature extending from one or more of the bag portion or the cushioning portion, the attachment feature adapted and configured to allow for attachment of the cargo bag to a substrate.

In another aspect, a cargo bag is in accordance with any of the preceding aspects, wherein the cushioning portion includes an inflatable portion, the inflatable portion being inflatable and deflatable between a storage configuration and a collapsed configuration, the inflatable portion including at least one valve adapted and configured to allow for inflation and deflation of the inflatable portion.

In another aspect, a cargo bag is in accordance with any of the preceding aspects, wherein the inflatable portion increases the rigidity of the cargo bag when inflated.

In another aspect, a cargo bag is in accordance with any of the preceding aspects wherein the inflatable portion is of drop stitch construction.

In another aspect, a cargo bag is in accordance with any of the preceding aspects, the cushioning portion includes a foam padded base.

In another aspect, a cargo bag is in accordance with any of the preceding aspects wherein the cushioning portion is adapted and configured to spread point loads from contents within the bag portion over an extended surface of the substrate.

In another aspect, a cargo bag is in accordance with any of the preceding aspects wherein the attachment feature is adapted and configured to provide releasable attachment of the cargo bag to a substrate without the use of straps.

In another aspect, a cargo bag is in accordance with any of the preceding aspects wherein the attachment feature is a keder strip extending from the cargo bag and adapted and configured to be received by an attachment device securable to the substrate.

In another aspect, a cargo bag is in accordance with any of the preceding aspects wherein the attachment feature is a keder strip includes a fabric wrapped at least semi-rigid rod, and wherein the fabric portion of the keder strip is sown to a flexible strip, the flexible strip being glued to at least one of the bag portion or the cushioning portion.

In another aspect, a cargo bag is in accordance with any of the preceding aspects wherein the attachment feature is formed in an inflatable portion forming the cushioning portion and provides an opening allowing the inflatable portion to be grasped by an attachment device securable to the substrate.

In another aspect, a cargo bag is in accordance with any of the preceding aspects wherein the cushioning portion is integral with the bag portion.

In another aspect, a cargo bag is in accordance with any of the preceding aspects wherein the cushioning portion is fastened to the bag portion by one or more fasteners.

In another aspect, a cargo bag is in accordance with any of the preceding aspects wherein the fasteners are one or more of adhesive, snaps, or thread.

In another aspect, a cargo bag is in accordance with any of the preceding aspects wherein the cushioning portion and the bag portion are separable.

In another aspect, a cargo bag is in accordance with any of the preceding aspects wherein the cushioning portion and the bag portion are separable and are removably joined by a zipper extending the circumference of the cargo bag near the cushioning portion.

In another aspect, a cargo bag is in accordance with any of the preceding aspects wherein the bag portion is generally wedge shaped when filled to provide an aerodynamic shape.

In another aspect, a cargo bag is in accordance with any of the preceding aspects wherein the bag portion includes a rectangular section extending from the wedge shaped section and joining with the cushioning portion, and wherein the bag portion includes a zipper positioned in the rectangular section to allow access to the interior of the bag portion.

In another aspect, a cargo bag is in accordance with any of the preceding aspects further includes a zipper coupled to the bag portion.

In another aspect, a cargo bag is in accordance with any of the preceding aspects wherein the substrate is a vehicle roof, vehicle window, building window, boat, or building wall.

In another aspect, a collapsible and expandable weather-resistant cargo bag system includes: a cargo bag includes: a bag portion constructed a weather-resistant material and adapted and configured contain contents and allow for storage and removal of contents through a closable opening; a cushioning portion coupled to the bag portion, the cushioning portion being expandable and collapsible, the cushioning portion adapted and configured to protect a substrate by being positioned between the substrate on which the cargo bag is placed and the contents stored in the bag portion; and an attachment feature extending from one or more of the bag portion or the cushioning portion, the attachment feature adapted and configured to allow for attachment of the cargo bag to the substrate; and an attachment device adapted and configured to releasably couple to the attachment feature of the cargo bag, the attachment device being further adapted and configured to be secured to a substrate, the attachment device being further adapted and configured to secure the cargo bag to a substate without straps capable of contacting the substrate.

In another aspect, a cargo bag system is in accordance with any of the preceding aspects, wherein the attachment device is permanently fixed to the substrate.

In another aspect, a cargo bag system is in accordance with any of the preceding aspects, wherein the attachment device is removably couplable to the substrate.

In another aspect, a cargo bag system is in accordance with any of the preceding aspects wherein the attachment feature is a keder strip, and wherein the attachment device is a keder rail adapted and configured to removably and securely receive a keder strip being slid into the keder rail, and wherein the keder rail is permanently affixed to the substrate.

In another aspect, a cargo bag system is in accordance with any of the preceding aspects wherein the attachment feature is a keder strip, and wherein the attachment device includes an upper portion and a lower portion forming an opening sized to contain the keder strip and an engagement feature adapted and configured to move the upper portion and the lower portion between an open position and a closed position, the open position allowing insertion of the keder strip into the opening and the closed position securing the keder strip within the opening.

In another aspect, a cargo bag system is in accordance with any of the preceding aspects, wherein the engagement feature includes a bolt captive in the lower portion and a nut above the upper portion and adapted and configured to be tightened to draw the upper portion and the lower portion together.

In another aspect, a cargo bag system is in accordance with any of the preceding aspects, wherein the engagement feature includes a cam lever adapted and configured to engage with a post coupled to the lower portion and having a cam lobe adapted and configured to engage with the upper portion to cam the upper portion and lower portion together and release to allow the upper portion and the lower portion to separate.

In another aspect, a cargo bag system is in accordance with any of the preceding aspects, wherein the attachment feature is toroid portion formed in an inflatable portion includes the cushioning portion, and wherein the attachment device includes an upper portion and a lower portion forming an opening sized to contain a portion of the toroid and an engagement feature adapted and configured to move the upper portion and the lower portion between an open position and a closed position, the open position allowing insertion of the toroid portion into the opening and the closed position securing the toroid portion within the opening, the upper and lower portion meeting in the void of the toroid when in the closed position.

In another aspect, a cargo bag system is in accordance with any of the preceding aspects further includes a vacuum device coupled to the attachment device, the vacuum device includes a cup, pump, and valve, the cup adapted and configured to seal to the substrate, the pump adapted and configured to remove air from the cup to secure the cup to the substrate with a vacuum within the cup, and the valve adapted and configured to be openable to release the vacuum within the cup and be closed to maintain a vacuum within the cup.

In another aspect, a cargo bag system is in accordance with any of the preceding aspects, includes four attachment devices adapted and configured to secure four corners of the cargo bag to the substrate.

In another aspect, a cargo bag system is in accordance with any of the preceding aspects, includes a plurality of attachment devices adapted and configured to engage with an attachment feature on the leading edge of the cargo bag and an attachment feature of the trailing edge of the cargo bag to secure the cargo bag to the substrate in front the leading edge of the cargo bag and behind the trailing edge of the cargo bag.

In another aspect, a cargo bag system is in accordance with any of the preceding aspects, wherein the attachment device includes a mount for coupling a wind deflector to the attachment device.

In another aspect, a cargo bag system is in accordance with any of the preceding aspects, wherein the attachment device or vacuum device includes an integrated wind deflector.

In another aspect, a cargo bag system is in accordance with any of the preceding aspects, wherein the bag portion includes a rigid shell having a bottom opening larger than the cushioning portion, the rigid shell adapted and configured to be placeable over contents placed on the cushioning portion and the cushioning pad, the cushioning pad being placed on the substrate and not attached to the substrate, and wherein the rigid shell is affixed to a plurality of vacuum devices adapted and configured to releasably couple the rigid shell to the substrate around the contents and cushioning portion.

In another aspect, a cargo bag system is in accordance with any of the preceding aspects, wherein the cushioning portion includes an inflatable portion, the inflatable portion being inflatable and deflatable between a storage configuration and a collapsed configuration, the inflatable portion including at least one valve adapted and configured to allow for inflation and deflation of the inflatable portion.

In another aspect, a cargo bag system is in accordance with any of the preceding aspects, wherein the inflatable portion increases the rigidity of the cargo bag when inflated.

In another aspect, a cargo bag system is in accordance with any of the preceding aspects wherein the inflatable portion is of drop stitch construction.

In another aspect, a cargo bag system is in accordance with any of the preceding aspects, the cushioning portion includes a foam padded base.

In another aspect, a cargo bag system is in accordance with any of the preceding aspects wherein the cushioning portion is adapted and configured to spread point loads from contents within the bag portion over an extended surface of the substrate.

In another aspect, a cargo bag system is in accordance with any of the preceding aspects wherein the attachment feature is adapted and configured to provide releasable attachment of the cargo bag to a substrate without the use of straps.

In another aspect, a cargo bag system is in accordance with any of the preceding aspects wherein the attachment feature is a keder strip extending from the cargo bag and adapted and configured to be received by an attachment device securable to the substrate.

In another aspect, a cargo bag system is in accordance with any of the preceding aspects wherein the attachment feature is a keder strip includes a fabric wrapped at least semi-rigid rod, and wherein the fabric portion of the keder strip is sown to a flexible strip, the flexible strip being glued to at least one of the bag portion or the cushioning portion.

In another aspect, a cargo bag system is in accordance with any of the preceding aspects wherein the attachment feature is formed in an inflatable portion forming the cushioning portion and provides an opening allowing the inflatable portion to be grasped by an attachment device securable to the substrate.

In another aspect, a cargo bag system is in accordance with any of the preceding aspects wherein the cushioning portion is integral with the bag portion.

In another aspect, a cargo bag system is in accordance with any of the preceding aspects wherein the cushioning portion is fastened to the bag portion by one or more fasteners.

In another aspect, a cargo bag system is in accordance with any of the preceding aspects wherein the fasteners are one or more of adhesive, snaps, or thread.

In another aspect, a cargo bag system is in accordance with any of the preceding aspects wherein the cushioning portion and the bag portion are separable.

In another aspect, a cargo bag system is in accordance with any of the preceding aspects wherein the cushioning portion and the bag portion are separable and are removably joined by a zipper extending the circumference of the cargo bag near the cushioning portion.

In another aspect, a cargo bag system is in accordance with any of the preceding aspects wherein the bag portion is generally wedge shaped when filled to provide an aerodynamic shape.

In another aspect, a cargo bag system is in accordance with any of the preceding aspects wherein the bag portion includes a rectangular section extending from the wedge shaped section and joining with the cushioning portion, and wherein the bag portion includes a zipper positioned in the rectangular section to allow access to the interior of the bag portion.

In another aspect, a cargo bag system is in accordance with any of the preceding aspects further includes a zipper coupled to the bag portion.

In another aspect, a cargo bag system is in accordance with any of the preceding aspects wherein the substrate is a vehicle roof, vehicle window, building window, boat, or building wall.

### DESCRIPTION OF THE DRAWINGS

In the accompanying drawings which form part of the specification:

FIG. 1 illustrates a secure cushioning cargo bag according to one embodiment;

FIG. 2 is a schematic side view illustration of the cargo bag of FIG. 1 being secured to a substrate with vacuum devices;

FIG. 3 is a schematic top view illustration of the cargo bag shown in FIG. 2;

FIG. 4 illustrates a collapsible and inflatable portion of the cargo bag of FIG. 1 that is rigid when inflated;

FIG. 5 is a partial cross-sectional view of the collapsible and inflatable portion of the cargo bag shown in FIG. 4;

FIG. 6 illustrates the leading edge of the cardo bag of FIG. 1 and shows a connection point according to one embodiment;

FIG. 7 is a detail view of FIG. 6 showing a water egress point;

FIG. 8 is a detail view of the cargo bag of FIG. 1 showing a fastener for removably securing a bag portion of the cargo bag to a collapsible and inflatable portion of the cargo bag;

FIG. 9 illustrates the cargo bag shown in FIG. 1 in a collapsed and stowed configuration;

FIG. 10 is a schematic side view of a vacuum device for securing the cargo bag with alternative bag attachment devices;

FIG. 11A is a schematic, cross-section view of a vacuum device and attachment device for coupling to the cargo bag shown in FIG. 1;

FIG. 11B is a schematic, partial cross-section view of a vacuum device and attachment device for coupling to the cargo bag shown in FIG. 1;

FIG. 12 is a schematic, partial cross-section view of a vacuum device and alternative attachment device for coupling to the cargo bag shown in FIG. 1;

FIG. 13 is a schematic, perspective view of an alternative attachment device for coupling the vacuum device to the cargo bag shown in FIG. 1;

FIG. 14 is a schematic, perspective view of an alternative attachment device for coupling the vacuum device to the cargo bag shown in FIG. 1;

FIG. 15 is a schematic, perspective view of an alternative attachment device with a mount for a wind deflector;

FIG. 16 is a schematic, perspective view of an alternative cargo bag with an attachment feature integrated with the inflatable portion of the cargo bag;

FIG. 17 is a schematic, perspective view of an attachment device coupled to the integrated attachment feature of the cargo bag shown in FIG. 16;

FIG. 18 is a schematic, partially exploded, perspective view of an exemplary vacuum device according to one embodiment;

FIG. 19 is perspective view of a vacuum device with an integrated win deflector;

FIG. 20 is a view of an alternative attachment device for coupling the cargo bag to the vacuum device and corresponding alternative attachment feature;

FIG. 21 is a schematic, perspective view of a rigid cargo shell couplable to a substrate to secure an inflatable cargo pad and cargo within the rigid cargo shell and relative to the substrate;

FIG. 22 is a schematic, perspective view of an alternative rigid cargo shell;

FIG. 23 is a schematic, side view of the cargo bag of FIG. 1 showing water resisting features;

FIG. 24 is an illustration showing further water resisting features and water egress features;

FIG. 25A is an illustration showing an alternative embodiment of the cargo bag of FIG. 1 with a semi-rigid upper section;

FIG. 25B is an illustration showing an alternative embodiment of the cargo bag of FIG. 25A with a semi-rigid trailing edge section; and

FIGS. 25C-25D illustrate further alternatives.

Corresponding reference numerals indicate corresponding parts throughout the several figures of the drawings. Like depictions similarly indicate corresponding parts throughout except where otherwise noted.

### DETAILED DESCRIPTION

The following detailed description illustrates the disclosed secure cushioning cargo bag by way of example and not by way of limitation. The description enables one skilled in the art to make and use the disclosed cargo bag, describes several embodiments, adaptations, variations, alternatives, and uses of the cargo bag, including what is presently believed to be the best mode of making and using the cushioning cargo bag. Additionally, it is to be understood that the cargo bag is not limited to the details of construction and the arrangements of components set forth in the following description or illustrated in the drawings. The disclosed cargo bag is capable of other embodiments and of being practiced or being carried out in various ways. Also, it is to be understood that the phraseology and terminology used herein is for the purpose of description and should not be regarded as limiting.

As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to practice the disclosure and are not intended to limit the scope of the appended claims.

Unless otherwise defined, all technical and scientific terms used herein have the same meaning as commonly understood by one of ordinary skill in the art to which this disclosure belongs. The terminology used herein is for the purpose of describing particular example embodiments only and is not intended to be limiting. As used herein, the singular forms “a”, “an”, and “the” may be intended to include the plural forms as well, unless the context clearly indicates otherwise. The terms “comprises”, “comprising”, “including”, and “having” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps can be employed.

When an element, object, device, apparatus, component, region or section, etc., is referred to as being “on”, “engaged to or with”, “connected to or with”, or “coupled to or with” another element, object, device, apparatus, component, region or section, etc., it can be directly on, engaged, connected or coupled to or with the other element, object, device, apparatus, component, region or section, etc., or intervening elements, objects, devices, apparatuses, components, regions or sections, etc., can be present. In contrast, when an element, object, device, apparatus, component, region or section, etc., is referred to as being “directly on”, “directly engaged to”, “directly connected to”, or “directly coupled to” another element, object, device, apparatus, component, region or section, etc., there may be no intervening elements, objects, devices, apparatuses, components, regions or sections, etc., present. Other words used to describe the relationship between elements, objects, devices, apparatuses, components, regions or sections, etc., should be interpreted in a like fashion (e.g., “between” versus “directly between”, “adjacent” versus “directly adjacent”, etc.).

As used herein the phrase “operably connected to” will be understood to mean two are more elements, objects, devices, apparatuses, components, etc., that are directly or indirectly connected to each other in an operational and/or cooperative manner such that operation or function of at least one of the elements, objects, devices, apparatuses, components, etc., imparts are causes operation or function of at least one other of the elements, objects, devices, apparatuses, components, etc. Such imparting or causing of operation or function can be unilateral or bilateral.

As used herein, the term “and/or” includes any and all combinations of one or more of the associated listed items. For example, A and/or B includes A alone, or B alone, or both A and B.

Although the terms first, second, third, etc. can be used herein to describe various elements, objects, devices, apparatuses, components, regions or sections, etc., these elements, objects, devices, apparatuses, components, regions or sections, etc., should not be limited by these terms. These terms may be used only to distinguish one element, object, device, apparatus, component, region or section, etc., from another element, object, device, apparatus, component, region or section, etc., and do not necessarily imply a sequence or order unless clearly indicated by the context.

Moreover, it will be understood that various directions such as “upper”, “lower”, “bottom”, “top”, “left”, “right”, “first”, “second” and so forth are made only with respect to explanation in conjunction with the drawings, and that components may be oriented differently, for instance, during transportation and manufacturing as well as operation. Because many varying and different embodiments may be made within the scope of the concept(s) taught herein, and because many modifications may be made in the embodiments described herein, it is to be understood that the details herein are to be interpreted as illustrative and non-limiting.

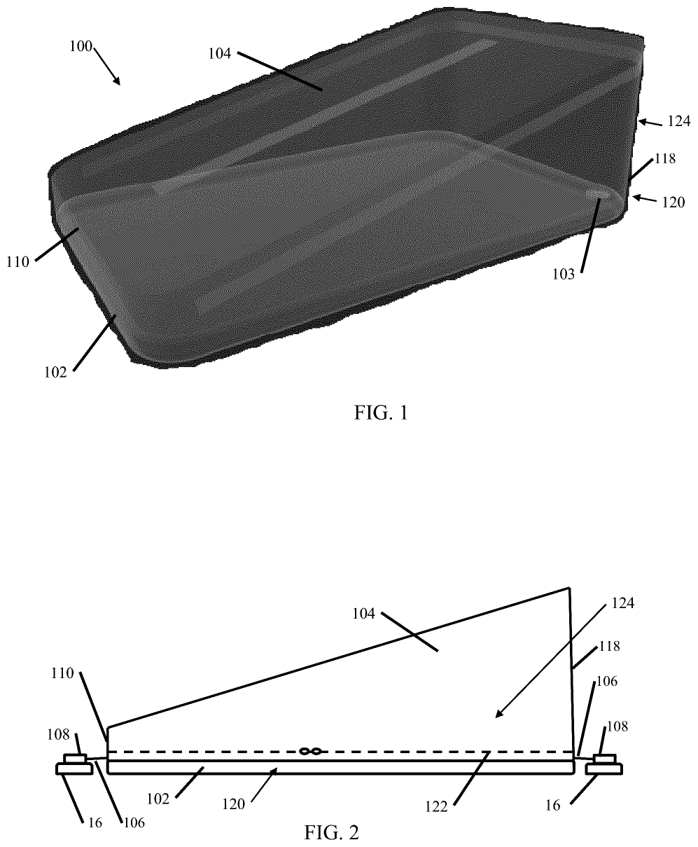

Referring generally to FIGS. 1-24, a cargo bag 100 includes an inflatable portion 102, a bag portion 104, and an attachment feature 106. The Inflatable portion 102 can be inflated and deflated to provide for the point load spreading as described herein. The bag portion 104 is openable and closable in order to store and remove cargo from the cargo bag 100 (e.g., using a zipper). The attachment feature 106 is portion of the cargo bag 100 that allows for the cargo bag to be secured to a substrate (e.g., vehicle roof) using an attachment device 108, not a portion of the cargo bag, which is adapted and configured to selectively interface with the attachment feature 106 of the cargo bag 100. For example, the attachment feature 106 is a keder strip (e.g., fabric wrapped rigid rod) extending from the cargo bag 100 and the attachment device 108 is a clamp adapted and configured to interface with the keder strip. The attachment device 108 is secured to the substrate (e.g., vehicle roof) either permanently or releasably. For example, the attachment device is secured to or forms a part of a vacuum device 16 adapted and configured to releasably attach to the substrate (e.g., vehicle roof) using a vacuum. The attachment feature 106 and attachment device 108 provide for securing the cargo bag 100 to a substrate without the use of straps providing the benefits described herein (e.g., a reduction in noise and damage that can be caused by straps or strap ends blowing the in the wind when a cargo bag is used on a vehicle roof).

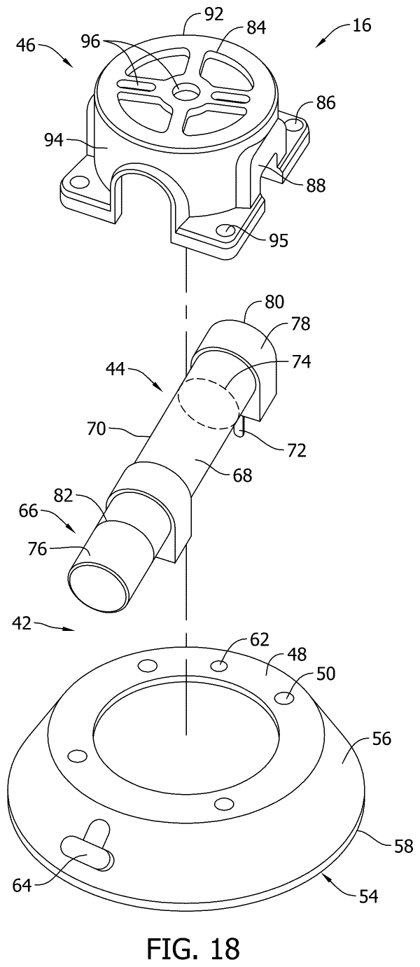

Still referring to FIGS. 1-24 generally, in one embodiment the leading edge 110 of the bag 100 incorporates a keder strip 112 and a custom vacuum mount 16 (with an attachment device 108) is attached via a built-in screw down clamp 114. The screw down clamp 114 is unscrewed to loosen opening 116, the clamp 114 is placed around the keder strip 112 with the keder strip 112 in the opening 116, and the screw down clamp 114 is tightened to secure the attachment device 108 and vacuum device 16 to the cargo bag 100. The vacuum device 16 is of a type manufactured by SeaSucker and are described in greater detail later herein with respect to FIG. 18. These incorporate a built-in pump with an indicator to show if any air has released. The cargo bag 100 can be used with multiple cups (vacuum device 16) on the leading edge 110 which keeps the bag down and stable (e.g., in wind as a vehicle is moving). Cups (vacuum devices 16 and attachment devices 108) can be added on the trailing edge 118 as well but typically only one cup per corner on the trailing edge will suffice. No straps to fly around in the wind and scratch the car and make very loud noises.

In other embodiments, other attachment devices 108 are used to connect the bag 100 to the vacuum devices 16. Small straps could attach to a d-ring (not shown) incorporated into the vacuum device 16 or directly to the car itself so that the straps or other methods can removably affix the storage assembly onto the car or other surface. Such small straps differ from existing strap use in that existing straps have an adjustable length such that extra material is subject to being blown in the wind and striking the vehicle. Small straps of the type used with the cargo bag 100 are sufficiently short to prevent the strap from contacting the vehicle. In further alternative embodiments, the cargo bag 100 can be directly fastened to the substrate (e.g., vehicle roof) via suction cups or other devices and also indirectly affixed by using a variety of means to prevent it from substantially moving during transport (e.g., additional straps or the like).

In further alternative embodiments, the cargo bag is removably coupled to a permeant portion of the substrate (e.g., vehicle roof) rather through the use of a vacuum device 16 and/or attachment device 108. For example, a female keder rail, adapted and configured to engage with the keder strip 112, can be screwed one, welded to, glued to, or otherwise incorporated into a vehicle roof or other substrate at time of manufacture (e.g., by the vehicle manufacturer). The cargo bag can then slide on connecting the keder strip 112 into the keder rail (not shown). In still further embodiments, the attachment device 108 as described herein can be permanently or removably coupled to the substrate (e.g., vehicle roof) at the time of manufacture. The keder strip 112 or other attachment feature 106 of the cargo bag can then be secured using the attachment device 108 as described herein without use of the vacuum devise 16.

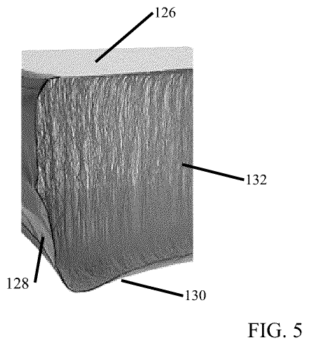

Referring still to FIGS. 1-24 generally, the bottom of the cargo bag 100 incorporates an air inflatable bladder (inflatable portion 102). The air inflatable bladder can be of what is commonly known as “drop stitch construction”. Dropstitch construction allows for an inflated structure to retain a pre-determined geometry once inflated due to a myriad of internal strings which are uniformly spaced and traditionally of equal length (as shown in FIG. 5). Typical spacing is approximately one quarter inch and the result is that the airbed maintains a flat surface similar to a sleeping mattress instead of the natural spherical surface an inflated membrane would default towards.

Dropstitch pads are typically constructed of a PVC outer membrane that holds the air and internally is a woven fabric. This construction is very durable and provides rigidity due to the internal strings limiting deformation of the outer membrane relative to other portions of the outer membrane. The rigidity is not absolute though which advantageously allows the cargo bag 100 and inflatable portion 102 to conform to the substrate (e.g., vehicle roof), for example, where the substrate curves or otherwise has a non-flat geometry. This further aids the load spreading provided by the inflatable portion 102.

The advantage of using dropstitch construction is that a relatively thin 2 inch thick pad (e.g., inflatable portion 102) can elevate a considerable amount of weight and evenly distribute a point load to the supporting rooftop of the car (or other substrate) so that the point-loading that would normally deform the sheet metal (or other substrate material) is distributed into a wider surface.

Experimentally, even 50 pound pieces of luggage can easily fit in the cargo bag 100 and on the inflatable portion 102 and do not reach, push into, or impede down to the rooftop even at 3-5 pounds per square inch inflation of the inflatable portion 102. The flexibility of the inflated pad allows it to conform to the rooftop and support a great load while protecting the substrate from damage. Due to the inflated nature, the bag has structure while inflated, but can collapse and greatly reduce its size for stowage or transport on a plane or other means of travel. It takes less than a minute to manually pump up the air bed (inflatable portion 102).

The cargo bag 102 also includes several features that provide water resistance or water proofing. The lower section 120 of the cargo bag is best made with polyvinylchloride (PVC). In some embodiments, just at or above the top of the inflatable portion 102 a zipper 122 is positioned allowing access to the bag portion 104. In an upper section 124 (e.g., above the zipper 122) the construction material can differ from that of the lower section 120 depending on the use case. This convertible feature could allow the same ultra-durable PVC base to be combined either with an ultra-durable top “canopy” or alternatively a lightweight and pack-able material such as a TPU material, or a Cordura® or ripstop nylon or other material depending on the use criteria.

Similarly with the changing of the convertible top durability or waterproofness, the top sections could be of various sizes and shapes so that a relatively generic lower dropstitch pad can be temporarily combined with upper sections of various utility due to the incorporation of a “fully separating zipper” 122 which goes around 360 degrees on the inflatable portion 102 and the cargo bag 100. An upper section 124 with a more specific dimension can be zippered on that might fit golf bags for instance much better, or an upper section 124 with a hole or tail incorporated for longer items like skis. The upper section 124 can also extend past the “footprint” of the inflated pad (inflatable portion 102) to accommodate loads like golf clubs that can cantilever over the inflated area.

In some embodiments, the attachment device 108 that engages with the attachment feature 106 (e.g., keder strip) or other portion of the vacuum device 16 also incorporates a slot for the purpose of threading through a tie down strap. If the bag is not full of luggage and there is a desire to tighten down the load to be more aerodynamic straps can go from leading edge 110 vacuum devices 16 to trailing edge 118 vacuum devices 16. This way straps do not cross over the bag like current bags on the market (e.g., straps which longitudinally attach the bag to a vehicle) which catch a lot of air but in this embodiment the strap length is parallel to the wind direction. This eliminates the “oscillation” of the strap that produces an annoying “hum” and sometimes causes the strap to contact the vehicle roof and cause damage.

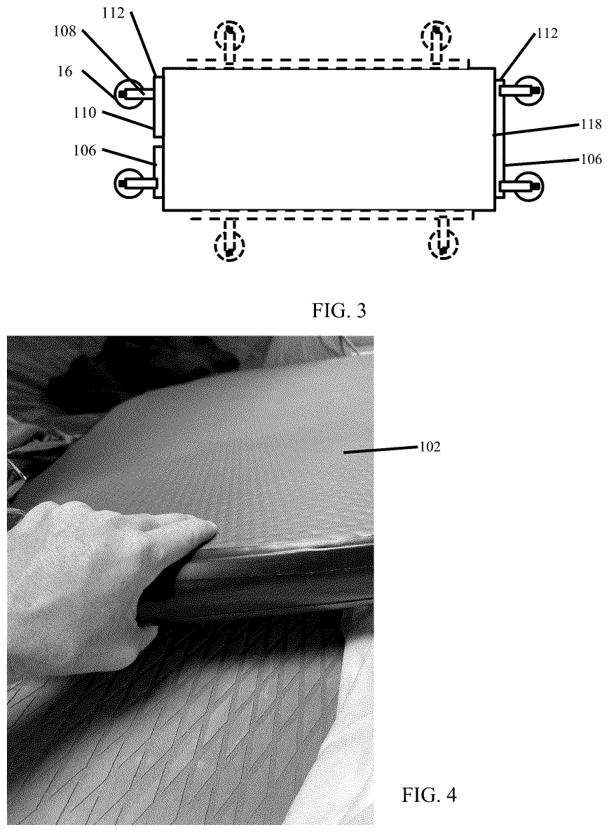

In the preferred embodiment, the cargo bag 100 includes Best a small space at center between 2 strips of the keder strip on the leading edge 110 (as shown in FIG. 3). This enables the cargo bag to be easily folded along a center line running from leading edge 110 to trailing edge 118. A one half to two inch space works well. The bag once deflated can be folded at center and then rolled up and can fit in a 60 liter bag for storage and travel. In some embodiments similar spaces are allowed for in keder strip or other attachment features 106 along all or a subset of the leading edge 110, trailing edge 118, first side edge, and/or second side edge (the side edges being optional and shown in dashed lines in FIG. 3).

In some embodiments, the cargo bag 100 includes an additional abrasive dampening cloth such as a polyester fleece, felt, or similar material to form a buffer between the inflatable pad/portion 102 and the substrate (e.g., vehicle roof), similar to the way a saddle blanket provides and interface between the saddle and the horse. A variety of techniques/components can be used to affix this abrasive dampening cloth to the overall storage system including, but not limited incorporating an additional keder strip below the primary one which can be used to add the abrasive dampening layer which includes a keder rail to interface with the secondary keder strip coupled to the cargo bag 100. In an alternative embodiment, the abrasive dampening layer can snap on to the vacuum devices 16 or attachment devices 108 via clips, snaps, or other suitable fasteners. The weight of the bag will also help keep the abrasive dampening layer aligned under the bag. Importantly, this abrasion dampening layer/pad can be removed easily and put through a standard washer and dryer at home or swapped out with a spare.

The construction techniques described herein can also be used to create a smaller backpack, duffle, or luggage apparatus as well. One or multiple vacuum devices 16 can be integrated to such a bag or snapped or screwed on to the bag. The vacuum devices 16 can be removed and stored in the bag when not in use. In this way individual bags can be attached to the rooftop or even to the rear glass of vans, wagons, or sport utility vehicles. Again the bottom portion of such bags can be inflatable to a depth of approximately 2 inches to keep any damage or scratching off the vehicle. A more compact use could be utilized for one piece of luggage at a time. Any abrasive dampening cloth (e.g., felt pad) can be attached by zipper, snaps, hook and loop fasteners, or other fastener on the back of the backpack, duffle, or luggage bag and then easily removed for washing. Incorporating the features disclosed here can work well on a large cargo bag that holds multiple luggage pieces or can also work well incorporating the features into individual bags.

Still referring generally to FIGS. 1-24 and prior to discussing the figures in greater detail individually, the general features of the cargo bag 100 are as follows. A flexible and collapsible/expandable weather-resistant enclosure (e.g., cargo bag 100) includes a padded base (e.g., inflatable portion 102) with a durable waterproof upper section (e.g., bag portion 104) capable of opening in a manner that allows one to removably store contents. This assembly contemplates an inflated base but which alternatively could be padded in order to isolate the contents of the bag from interacting with the surface upon which is mounted. A key component of the cargo bag 100 is the collapsible nature of this storage bag in that it can itself be stored in a dense form factor and then expanded to become a weather resistant storage many times the volume as compared to the compressed and compact mode. An additional key feature of the cargo bag 100 is its ability to firmly but removably affix to substrates without damaging the substrate and without permanently mounting hardware to the substrate. The preferred method of attachment is incorporating vacuum devices 16 with active spring vacuum generators such as found in SeaSucker® products. The vacuum cups (vacuum devices 16) can be a permanent feature of the cargo bag 100, however the ideal embodiment includes a provision for the vacuum cups to removably attach to the padded/inflated base of the weather-resistant storage bag in a multiplicity of locations along the perimeter of the bag. In some embodiments, the vacuum devices 16 are not limited to being attached to the perimeter of the bag. In such cases, the cargo bag 100 includes internal geometry allowing vacuum cups (vacuum devices 16) to be incorporated into the padding of the bag itself (either permanently or releasably using the same or similar attachment devices 108 as described herein). Such internal geometry can be provided for by the shape and structure of the inflatable portion 102.

In various embodiments, a variety of shapes of both the lower pad (e.g., inflatable portion 102) and the upper section (e.g., bag portion 104) to accommodate the varied use cases in the marketplace, sometimes with the upper and lower sections permanently bonded. In other embodiments the lower section and upper section may be fully separated with a zipper or other fastener (e.g., as shown in FIG. 2). In some embodiments, a multitude of upper storage sections (e.g., bag portions 104) can be affixed to the same lower padded section (e.g., inflatable portion 102), for example, using zippers extending around the circumference of each such section. These upper sections (e.g., bag portions 106) could vary in size, color, and/or material characteristics.

An important feature of the fully removable upper section is the ability to still removably affix the lower section (e.g., inflatable portion 102) and have attachment points (e.g., attachment features 106) permanently connected to the padded base so that the consumer can attach a variety of other things that may already be waterproof or impervious to the elements but which need a padded interface to the substrate. For example, if a little league coach has milk-crates full of baseballs and a car full of players, the milk crates can be strapped to the pad (e.g., inflatable portion 102) and the car is protected from scratches that the milk crates would make if strapped directly to the vehicles surface, but also the crates do not need to be protected from the rain, nor have the risk of a noisy/flapping upper section.

Referring now to FIG. 1, the cargo bag 100 is shown according to one embodiment. The cargo bag is generally wedge shaped in profile in order to provide an aerodynamic shape. In alternative embodiments, the cargo bag 100 has other shapes. The inflatable portion 102 is positioned at the bottom of the cargo bag 100. The inflatable portion 102 can be incorporated into the bag portion 104 or be attached permanently or releasably to the bag portion 104. The inflatable portion 102 extends from a leading edge 110 to a trailing edge 118. The inflatable portion 102 and the bag portion 104 can have the same or a different footprint. The inflatable portion 102 includes at least one valve 103 for inflating and deflating the inflatable portion 102. The at least one valve 103 can include a release valve or other overpressure protection. The at least one valve 103 is any suitable valve allowing for both inflation and deflation.

Referring now to FIGS. 2 and 3, the bag portion 104 in the depicted embodiment is permanently attached to the inflatable portion 102. In alternative embodiments, the two are separable (e.g., using a zipper extending the circumference of both). The bag portion 104 includes a zipper 122. In some embodiments, this zipper 122 allows for the complete separation of the majority of the bag portion 104 from the inflatable portion 102. In such an embodiment, the zipper 122 thus eliminates the need for a second zipper of the type described to separate the two portions. In some embodiments, the zipper 122 does not extend around the entire circumference of the bag portion 104 (e.g., extends around three sides). The zipper 122 includes two zipper cars. In all embodiments, the zipper 122 allows access to the bag portion 104 to stow and remove cargo. The zipper 122 can be positioned above the inflatable portion 102 but below the sloping leading edge.

The attachment feature 106 extends from the leading edge and in this embodiment is a keder strip 112. The keder strip 112 allows for coupling to the attachment device 108 coupled in turn to the vacuum device 16. The cargo bag 100 can further include an attachment device 106 extending from the trailing edge 118. This allows for coupling to attachment devices 108 and/or vacuum devices 16 in front of and behind the cargo bag 100. In some embodiments, the cargo bag 100 further includes attachment devices 106 (e.g., keder strips 112) on the sides of the cargo bag 100 (e.g., shown in dashed lines in FIG. 3). This can also allow for securing the sides of the cargo bag 100 using attachment devices 108 and/or vacuum devices 16 (as show in dashed lines in FIG. 3).

Referring now to FIG. 4, the inflatable portion 102 is shown in isolation according to one embodiment. As previously explained, the inflatable portion 102 is of drop stitch construction. The inflatable portion has a depth of two inches but in alternative embodiments can other depths. Referring to FIG. 5, a cross-section of the inflatable portion 102 of FIG. 4 is shown. The inflatable portion 102 being of drop stitch construction includes a top portion 126, side portions 128, and bottom portions 130 constructed of an airtight material (e.g., flexible plastic construction). At least the top portion 126 and the bottom portion 130 are joined by a plurality of strings, threads, or other flexible material 132. These strings provide the whole of the inflatable portion 102 with rigidity when inflated by limiting relative movement of the outer portions. The flexible nature of each individual component allows the inflatable portion 102 to be folded, rolled, or otherwise collapsed when deflated.

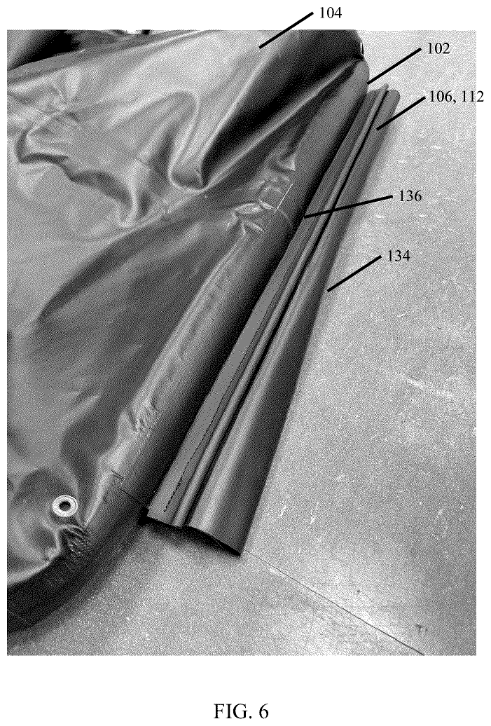

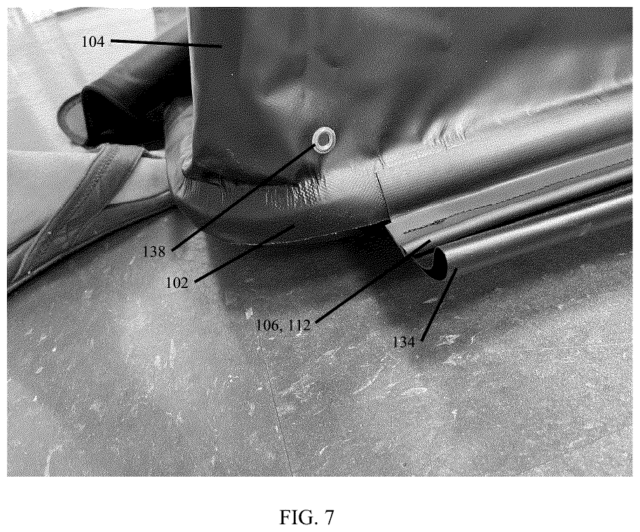

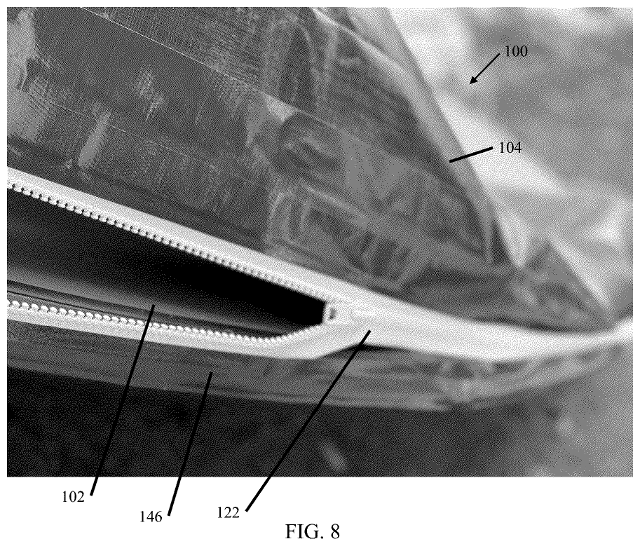

Referring now to FIGS. 6 and 7, the attachment feature 106 (e.g., keder strip 112) is attached to the cargo bag 100, in this case, indirectly. The keder strip 112 is stitched to a fabric or other flexible strip 134. The flexible strip 134 can be any suitable material and in some embodiments is the same material as the bag portion 104. The flexible strip 134 is attached to the cargo bag 100 using adhesive at or around the inflatable portion 102 (e.g., in region 136). This configuration allows for stitching of the keder strip 112 to the cargo bag 100 without compromising the airtight construction of the inflatable portion 102. In alternative embodiments, the keder strip 112 or other fastening features 106 can be attached without the strip 134, for example, by being glued directly to the cargo bag 100.

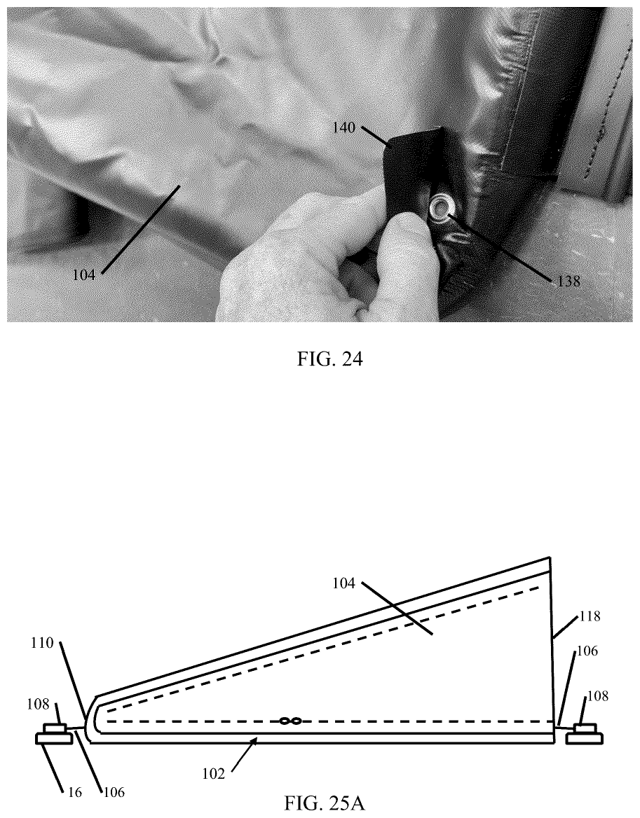

The bag portion 104 can include one or more water egress features 138. The water egress features are adapted and configured to allow any water that does happen to enter the bag portion 104 to escape rather than being trapped. The water egress feature 138 can be any component or feature for allowing water to exit the bag portion 104. For example, the water egress feature can be a one way valve, ball check valve, or similar feature. In the depicted embodiment, the water egress feature 138 is a gromet. Referring now to FIG. 24, a flap 140 is positioned above and/or around the water egress feature (e.g., grommet) 138. The flap 140 can be constructed of the same material as the bag portion 104 or other suitable material. The flap 140 is glued to the bag portion 104. In one embodiment, only the upper edge of the flap 140 is glued to the bag portion 104. In alternative embodiments, the upper edge and side edges of the flap 140 are glued to the bag portion 104.

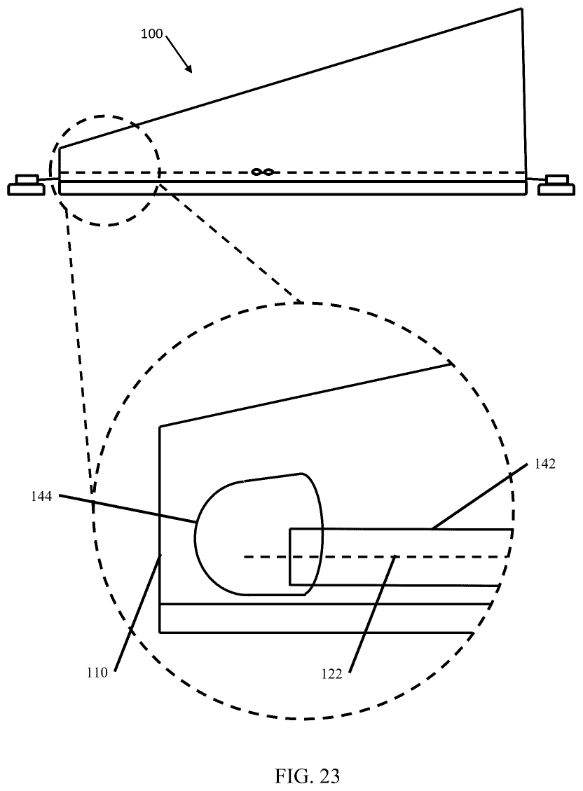

Referring now to FIG. 23, the cargo bag 100 can include other waterproofing or water resisting features. In some embodiments, the cargo bag 100 includes a flap 142 positioned over the zipper 122 that allows access to the zipper 122 while also covering the zipper 122 to reduce or prevent water from entering through the zipper 122. The flap 142 is any suitable material and can be the same material as the bag portion 104. The flap 142 is glued to the bag portion 104. In some embodiments, only the top edge/portion of the flap 142 is glued to the bag portion 104 to provide for access to the zipper 122. In some embodiments, the zipper 122 extends around the sides and trailing edge of the cargo bag but not the leading edge. In such embodiments, the zipper 122 terminates on the sides of the cargo bag 100 near the leading edge 110. In such embodiments, the cargo bag 100 can include a further flap 144. The flap 144 can contain the zipper slider(s) and protect the zipper sliders and adjacent zipper portions from water ingress. The flap 144 can be the same material as the bag portion 104 or other suitable material. The leading edge, top edge, and bottom edge of the flap 144 are glued to the bag portion 104. The trailing edge is left unglued to provide access to the zipper sliders.

Referring now to FIG. 8, in some embodiments the cargo bag 100 includes an inflatable portion 102 that is separable from the bag portion 104. The zipper 122 extends around the circumference of the cargo bag 100 and allows the two be unzipped from each other. In such embodiments, the inflatable portion 102 is positionable within a part of the bag portion 104 (e.g., lower portion 146). The inflatable portion 102 can be removable from the bag portion 104 including the lower portion 146. Alternatively, the inflatable portion 102 is secured to the lower portion 146 (e.g., by adhesive). In other embodiments including those in which the inflatable portion 102 is integral to the cargo bag 100 the inflatable portion 102 can be adhered to the bag portion 104 or removably placed in the bag portion 104.

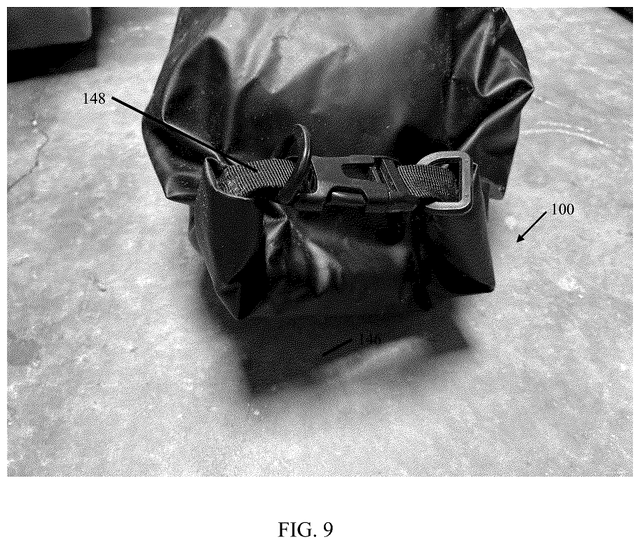

Referring now to FIG. 9, the cargo bag 100 is collapsible as previously described herein to a stored or stowed state as depicted. The features described herein allow for the collapsibility of the cargo bag 100 (e.g., the inflatable portion 102, the segmentation of the keder strip 112, etc.). The cargo bag 100 can include one or more securing elements 148 to secure the cargo bag in the collapsed state. For example and as depicted, the securing element 148 can be a captive strap and buckle. The securing element 148 can be any suitable fastener or fasteners to include a strap, belt and buckle, strap and D ring, snaps, hook and loop fasteners, or the like.

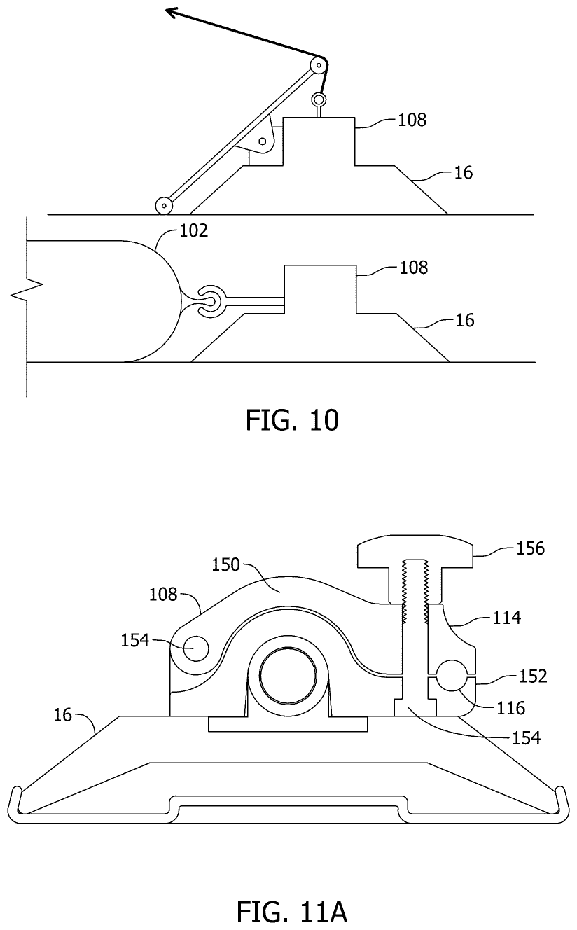

Referring now to FIG. 10, the attachment device 108 can vary depending on the use case. In some embodiments, the attachment device 108 includes a hook, hinge/fulcrum, and padded contact point. A cargo net is anchorable to the attachment device 108 using a hook and can be extended over cargo and/or the inflatable portion 102 to secure cargo. The pull of the cargo net causes the hinge/fulcrum to contact the substrate at the padded contact point. The fulcrum resists the forces of the cargo net, keeps the cargo net off the substrate, and/or assists in preventing the vacuum device 16 from being pulled free from the substrate. In an alternative embodiment or use case, the attachment device 108 is coupled to the inflatable portion 102 laterally as described herein.

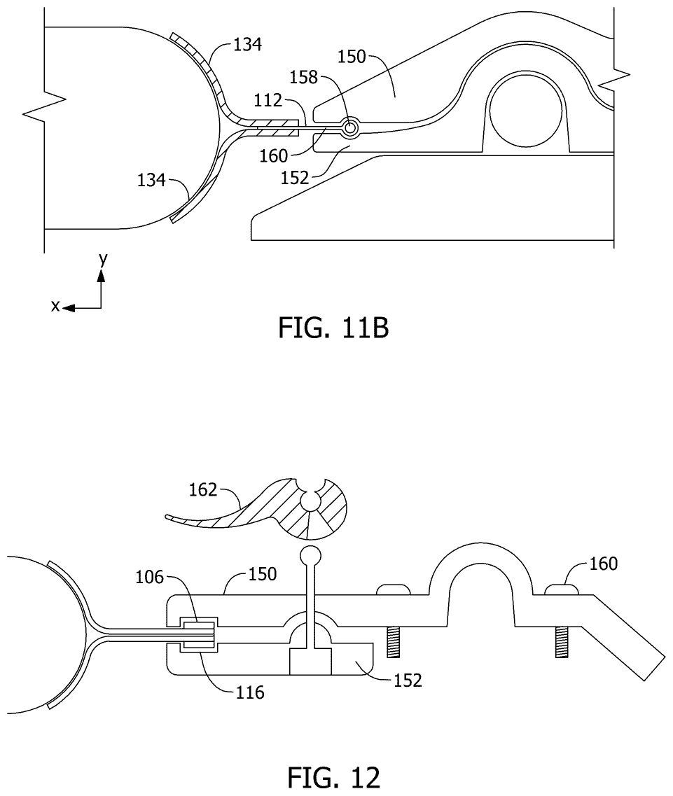

Referring now to FIG. 11A, an attachment device 108 and corresponding vacuum device 16 are illustrated according to one embodiment. The attachment device 108 is coupled to the vacuum device 16. In some embodiments, the attachment device is integral with the vacuum device 16 (e.g., a one part construction). In alternative embodiments, the attachment device 108 is coupled to the vacuum device using one or more fasteners such as screws, nuts and bolts, rivets, or the like. The attachment device 108 as previously described includes a top portion 150 and a bottom portion 152 in a clam shell configuration, the two portions pivotable about a pin 154. The top portion 150 and the bottom portion 152 form an opening 116 which can receive a keder strip 112. The attachment device 108 includes a captive bolt 154 and nut 156. The nut 156 can be tightened or loosened to provide access to the opening 116 or close off such access. This allows the keder strip 112 to be secured or released.

Referring now to FIG. 11B, the attachment device 108 is shown interfacing with the keder strip 112. The keder strip 112 is held in the opening 116 with an inference fit with the top portion 150 and the bottom portion 152. The keder strip 112 includes plastic or other material rigid core 158 wrapped in a fabric or other flexible material 160. The flexible material is in turn stitched (or otherwise attached) to the flexible strip 134. In some embodiments, the flexible strip 134 is two flexible strips with the keder strip 112 sandwiched between the flexible strips 134.

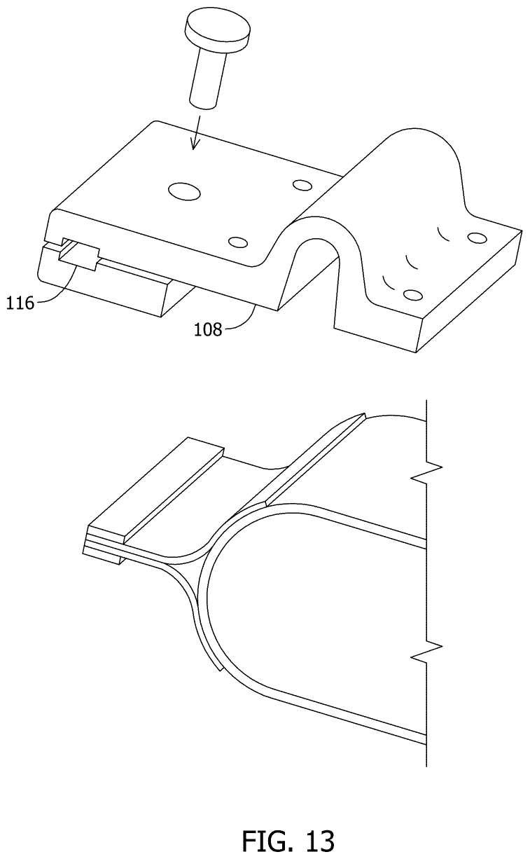

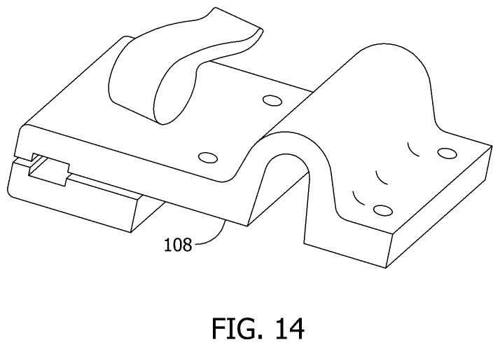

Referring now to FIG. 12, an alternative attachment device 108 is illustrated according to one embodiment. The attachment device 108 is couplable to a vacuum device 16 using screws 162. The attachment device 108 differs from the previously described attachment device in the following ways. A cam lever 162 replaces the bolt and nut to secure and release the attachment feature 106. The cam lever 162 interacts with a registration hump and post secured by a lock nut to cam the upper portion 150 down toward the bottom portion 152 and release the upper portion 150 away from the bottom portion 152. This selectively secures and releases the attachment feature 106. The attachment device 108 also differs in that the opening 116 is square in profile. The corresponding attachment feature 106 is also square in profile and can be a square keder strip or other similar feature. Referring now to FIG. 13, a further embodiment of the attachment device 108 is illustrated also having a square opening 116. Rather than a cam lever, this attachment device uses a thumbscrew to position the upper and lower portions to secure and release the attachment feature 106. Referring now to FIG. 14, a further attachment device 108 is illustrated. This attachment device differs in that a cam-lever in the style of a bike tire quick release is used to secure and release the upper and lower portions.

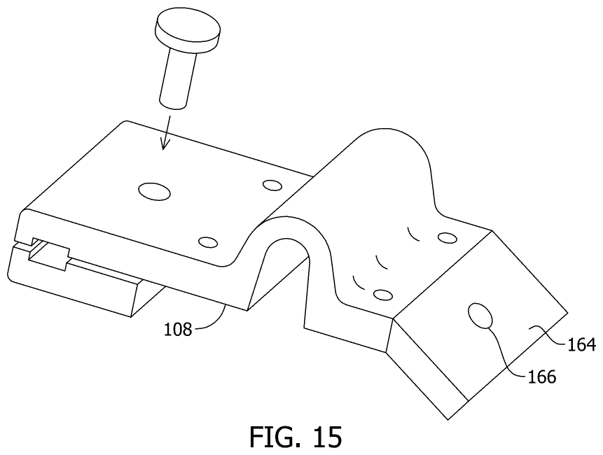

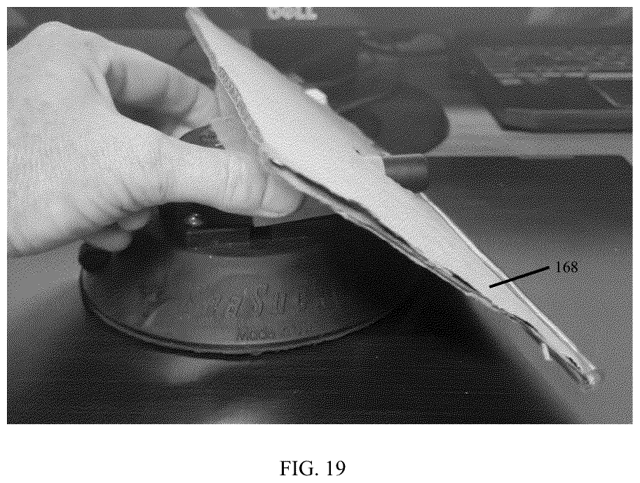

Referring now to FIG. 15, in some embodiments the attachment device 108 includes a wind deflector mount 164. The wind deflector mount is adapted and configured to allow a wind deflector to be attached to the attachment device 108. The wind deflector mount 164 can be angled (e.g., at a 45 degree angle). The wind deflector mount 164 can include a threaded hole 166 or other fastener component to allow a wind deflector to be attached to the attachment device 108. Referring now to FIG. 19, in some embodiments, the attachment device and/or the vacuum device 16 includes an integrated wind deflector 168.

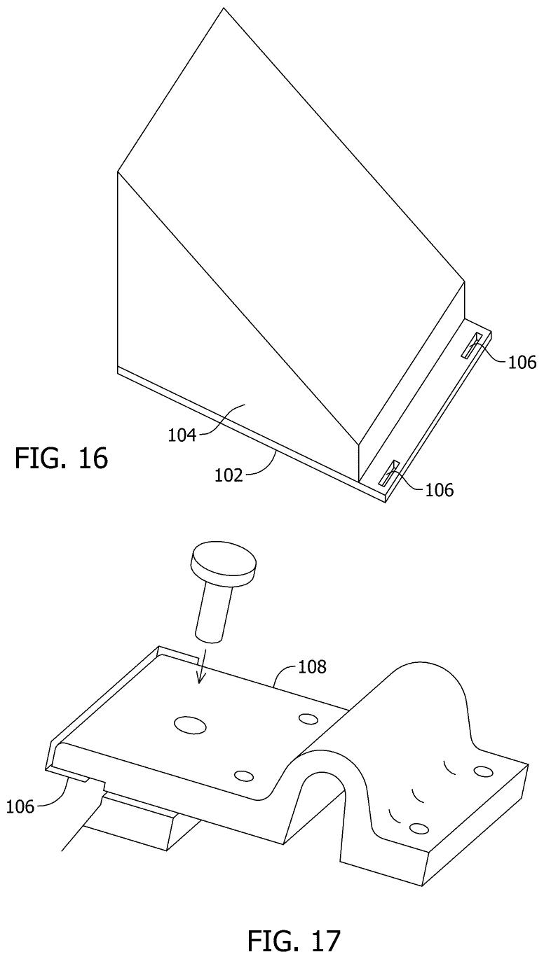

Referring now to FIGS. 16 and 17, in an alternative embodiment the attachment feature 106 is not a keder strip but is rather an opening in the inflatable portion 102 to provide for an attachment device 108 to engage with a portion of the inflatable portion 102 directly (e.g., allowing for intervening fabric or material layers if any, but in any case not needing additional features such as the keder strip). The opening or hole in the inflated pad 102 doesn't impede with the air tightness of the pad (think torus or toroid shape) and allows the suction cup to be affixed to the substrate and when viewed from the elevation (side view) it would protrude higher than the inflated portion of the pad. This allows the cups to be visually hidden and also tamper resistant, and would not involve a keder strip of any kind.

Referring now to FIG. 18, each vacuum device 16 includes a vacuum pad 42 and an attached vacuum pump 44. A housing 46 attaches to the vacuum pad 42 to enclose and secure the vacuum pump 44 to the vacuum pad 42. The housing is 46 shaped and sized to enclose the vacuum pump 44 while allowing for the attachment of an accessory and likewise to a surface of a vehicle.

In the instant embodiment, the vacuum pad 42 is generally a conical frustum that defines a top face 48 having threaded holes 50 to mount with the housing 46 using fasteners 52. The vacuum pad 42 also includes a recessed vacuum face 54 being generally parallel to the top face 48, a sloped side surface 56 extending between the top face 48 and the vacuum face 54, and a generally circumferential seating edge 58 along the perimeter of the vacuum face 54. In this arrangement, the seating edge 58 can seat with the mounting surface 17 of a vehicle to form a vacuum cavity 60. The vacuum pad 42 defines a channel 62 extending from the top face 48 to the vacuum face 54 and sized to mate with the vacuum pump 44.

Release tabs 64 extend outwardly from the side surface 56. The release tabs 64 are generally t-shaped ribs that are shaped and sized to enhance rigidity of the pad 42 and help prevent release of the vacuum device 16 from the mounting surface 17, such as during exposure to warmer temperatures.

Preferably, the pad 42 is made from a flexible material, such as, rubber, or plastic. However, the pad 42 can comprise any material that allows the vacuum pad 42 to seat with the mounting surface 17. Preferably, the material should not be prone to scuffing the mounting surface during installation or operation. In addition, the material can comprise any suitable color and may include other desirable attributes. For example, the pad 42 can be a reflective or glow-in-the-dark material so that it can be seen in dark environments.

The pump 44 in this embodiment includes a generally cylindrical plunger 66 and a hollow cylinder 68 that defines a chamber 70 sized and shaped to receive the plunger 66. The plunger 66 moves within the chamber 70 between a pressed position and a released position to create the vacuum cavity 60 between the vacuum face 54 and the mounting surface 17. The cylinder 68 has an opening to the chamber 70 at one end and is closed at the opposite end. A tube 72 extends generally perpendicularly from the closed end of the cylinder 68. The tube 72 is sized and shaped to insert into the channel 62 of the vacuum pad 42 to provide fluid communication between the cylinder chamber 70 and the vacuum cavity 60. The plunger 66 is sized to insert into the cylinder 68 with a sliding fit that allows the plunger 66 to move back and forth within the cylinder 68.

A check valve 74 is positioned within the cylinder chamber 70 in communication with the chamber 70 and the tube 72 so that fluids and gases can only transfer into the tube 72 from outside of the cylinder 68. This allows the vacuum device 16 to be re-pumped without loss of remaining vacuum. In an alternate embodiment, an automatic pump can be used to increase the vacuum level of the vacuum device if it falls below a pre-determined level. In another alternate embodiment, a vacuum device includes a signaling component capable of indicating or sending a signal that indicates a loss of a designated amount of pressure, including, but not limited to, an audio signal, a visual signal, an electronic signal, or a wireless or Bluetooth® signal. For instance, the signaling component can send a wireless signal to a wireless phone and, in conjunction with appropriate software on the phone, indicate the vacuum pressure.

The plunger 66 is generally a rod with a push button 76 at one end, a seal 78 at the opposite end, and a biasing member 80 there between. The seal 78 is sized and shaped to seat against the inner wall of the cylinder 68. When the plunger 66 inserts into the cylinder chamber 70, the biasing member 80 biases the plunger 66 to the released position. The position of the plunger 66 in the released position will vary respective to the amount of vacuum pressure within the vacuum cavity 60.

An indicator 82 positioned about the lower portion of the push button 76 indicates to the operator the relative amount of vacuum pressure within the vacuum cavity 60. The indicator 82 is a colored ring or sleeve sized and shaped to attach around the lower portion of the push button 76. The indicator 82 can be red, yellow or another color or indication that is easily seen. Additionally, the indicator 82 can be a reflective or glow-in-the-dark material so that it can be seen in dark atmospheres and under water. When no vacuum pressure exists in the vacuum cavity 60, the biasing member 80 extends the plunger 66 to its most extended release position. In this position, the indicator 82 is fully visible. As the pressure increases in the vacuum cavity 60, the force of the vacuum lessens the bias of the biasing member 80, and, in turn, the plunger 66 extends less from the chamber 70 and less of the indicator 82 is visible.

The housing 46 is a generally a cylindrical member with a generally rectangular base which includes a top surface 84, bottom surface 86, first side 88, second side 90, third side 92, and pump side 94 (FIG. 3). The bottom surface 86 of the housing 46 defines housing apertures 96 for attachment to the vacuum pad 42 with fasteners. The top surface 84 defines attachment apertures 98 for attachment of accessories with appropriate means, such as fasteners, straps, and other suitable members. Although, housing apertures 96 and attachment apertures 98 are shown on the top side 84 of housing 46, those skilled in the art will recognize that housing apertures 96 and attachment apertures 98 can be located on any side 88, 90, 92, 94 of the housing 46. Also, the housing apertures 96 and attachment apertures 98 can be holes, slots, or any other configuration sized and shaped to accommodate different dimensions of various manufacturers' accessories. The housing 46 can be made from a variety of materials, including marine grade stainless steel, powder-coated aluminum, rubber or plastic.

In general operation, an operator places the vacuum face 54 of pad 42 against a mounting surface 17 of a vehicle, which creates a vacuum cavity 60 between the vacuum face 54 of the pad 42 and mounting surface 17. The operator repeatedly pushes the plunger 44 from the released position to the pressed position to remove fluid (air, gas, and/or water) from the vacuum cavity 60, thereby, reducing the pressure below the pressure of the surrounding atmospheric pressure. This creates a vacuum such that edge 58 and vacuum face 54 of pad 42 seat against the mounting surface 17. A vacuum exists whenever the pressure within the space is less than the pressure that surrounds it. To obtain an adequate vacuum for operation, the operator should repeatedly press the plunger 66 until the indicator 82 is no longer visible when the plunger 66 is in the released position. If at any time during operation, the indicator 82 becomes visible indicating a loss of vacuum, the operator can again repeatedly push the plunger 66 until the indicator 82 is no longer visible.

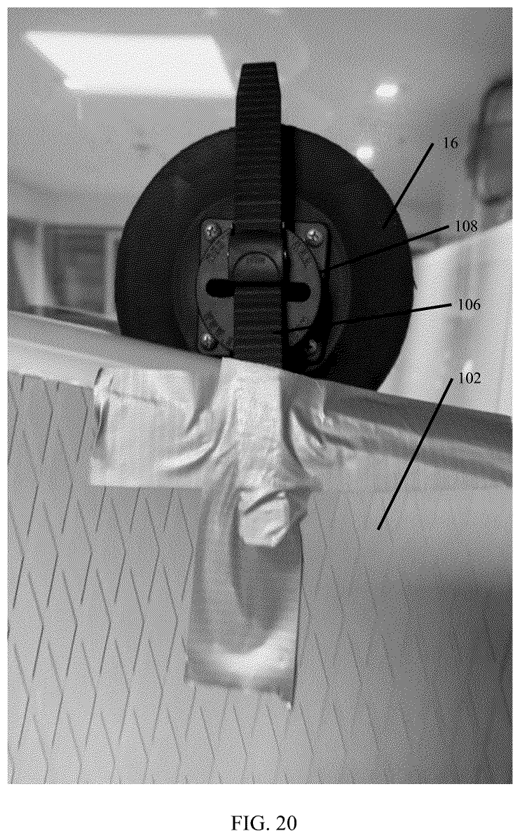

Referring now to FIG. 20, in a further alternative embodiment the attachment device 108 is a ratchet lever and the attachment feature 106 is a ladder strap.

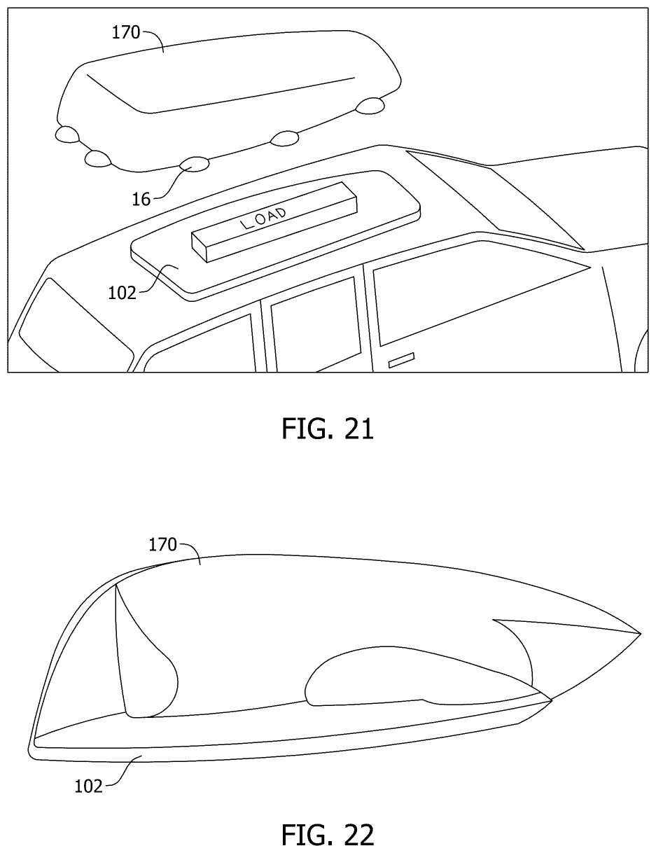

Referring now to FIGS. 21-22, in some embodiments the upper section 124 of the cargo bag 100 is substituted for a rigid upper section 170 removable from the inflatable portion 102. The inflatable portion 102 can be placed on the substrate (e.g., vehicle roof) and the cargo or load placed on the inflatable portion 102. The rigid upper section 170 has vacuum devices 16 attached (e.g., removable or not removable). The rigid upper section 170 can then be placed over the load and around the inflatable portion 102 and removably coupled to the substrate by the vacuum devices 16. The rigid upper section 170 keeps the cargo and inflatable portion 102 in place. In this iteration the inflated pad (e.g., inflatable portion 102) itself may not be affixed at all to the substrate, but instead is placed on the substrate, the cargo placed on the pad, and then the rigid hood is affixed to the substrate thereby fully encasing the pad and cargo and preventing the pad from moving laterally. The rigid upper portion 170 can be shaped to conform to vehicle roofs that are not substantially flat as can the inflatable portion 102.

In a further alternative embodiment a hybrid storage system includes a rigid upper section affixed to the inflated/padded lower section 102 (e.g., replacing the bag portion 104). In this variant, it is the upper section that is in communication with the attachment feature 106 pulling the top section down towards the substrate. This variant allows a low profile vacuum formed or injection molded “hood” to be affixed the car without having the flexible nature of the fabric upper section subject to rattling or wear and tear that happen from thousands of miles in the wind, or for instance in an off-road situation where the storage container may be in direct and repeated contact with brush or trees. Advantageously, this embodiment provides for the cushioning effect previously described through he inflatable portion 102 and a hard or rigid upper portion that provides protection to the cargo and does not require a roof rack, luggage rack, or other similar feature currently required by existing hard shell rooftop cargo systems.

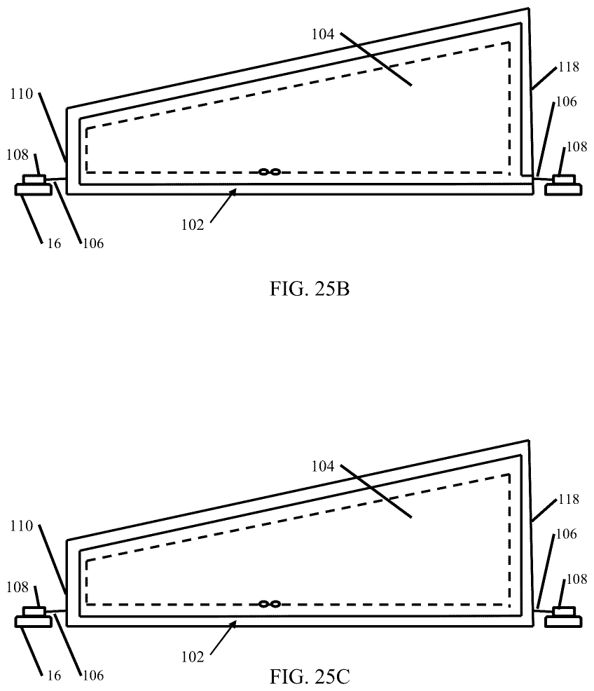

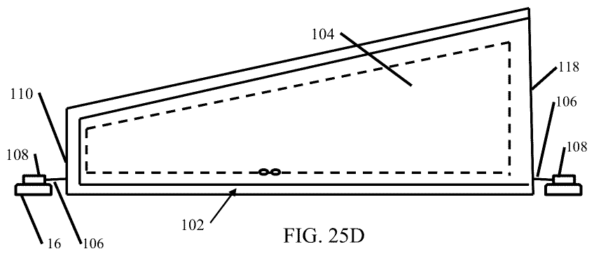

Referring now to FIGS. 25A-25D, in alternative embodiments, the inflatable portion 102 extends to provide for a semi-rigid or rigid (due to the drop stitch construction) upper or roof section. Referring to FIG. 25A, the inflatable portion 102 can provide a rigid or semi-rigid roof that can reduce or eliminate slapping or other wind induced movement. In such embodiments, the sides (e.g., left, right, and/or trailing edge side) are formed of flexible material (e.g., that of the bag portion 104). The bag portion 104 is attached to the inflatable portion 102 with a zipper allowing the for the entire side section to be removed. In alternative embodiments, the zipper only provides an opening and the bag portion 104 is not completely removable from the inflatable portion 102.

Referring now to FIG. 25B, in an alternative embodiment the inflatable portion 102 forms the bottom, leading edge, top, and trailing edge. Two separate side panels form the bag portion 104 and each one is completely removable by unzipping the sides from the inflatable portion 102.

Referring again to FIGS. 25A and 25B, in some embodiments the inflatable portion 102 includes a crease or other feature allowing for the geometry shown. For example, in FIG. 25A a single crease allows the inflatable portion 102 to be “folded” at the leading edge, in FIG. 25B three creases allow for an un-joined square configuration, in FIG. 25C four creases allow for a closed square configuration, and in FIG. 25D two creases allow for a square configuration with an open (e.g., non-rigid) back or trailing edge. In some or all cases, the side panels provided in bag portion 104 can assist in providing the overall structure (e.g., opposing a spring force of the inflatable portion 102). In a further alternative embodiment, the inflatable portion 102 shown in FIG. 25B extends as full square in cross section rather than a gap existing at the trailing edge (as shown in FIG. 25C). In such embodiments, the inflatable portion 102 can include four creases to assist in form the rigid or semi-rigid structure.

In some embodiments, the inflatable portion 102 of the cargo bag shown in FIG. 2 includes one or more creases to allow for the use in a variety of configurations. For example, the inflatable portion 102 can be folded at the crease(s) to provide a triangular or square cross section of the rigid or semi-rigid inflatable portion 102. The bag portion 104 can be switched with alternative bag portions 104 in order correspond to any of the selected configurations and assist in maintaining the structure of the cargo bag (e.g., by resisting an unfolding of the inflatable portion). In such embodiments, the cargo bag includes a plurality of attachment features 106 so that the cargo bag can be secured as described herein in any configuration selected by a user. For example, where the inflatable portion 102 as shown in FIG. 2 includes a plurality of creases for folding to different configurations, each crease location has a corresponding attachment feature 106 (e.g., a keder strip) such that if the existing leading edge is moved to a top side a new keder strip is available to serve as the leading edge attachment feature 106 and be secured to attachment device 108.

Referring again generally to FIGS. 1-24, various alternative embodiments make use of similar but different structures, constructions, techniques, materials, and the like. Experimentally, we have determined that an inflated pad (e.g., inflatable portion 102) is the best way to distribute loads to protect the substrate (e.g., vehicle roof) and is also the best construction to provide for compactness when the cargo bag 100 is not in use. However, alternative materials and constructions can be used in place of the inflatable portion 102 while maintaining similar functionality. For example, in place of an inflatable portion 102 the cargo bag 100 can include a foam pad (e.g., approximately 2 inches thick). The foam pad can be of any suitable construction and can include open and/or closed cell foam materials.

It should also be understood that although the cargo bag 100 is depicted as being securable using vacuum devices 16, other suitable attachment techniques, components, and devices can be used. In alternative embodiments, the cargo bag 100 can be tied to existing roof racks or be secured by running a strap through the door openings of a car. Also, while depicted as a keder strip, the attachment feature 106 can be any suitable feature. In some embodiments, the attachment features 106 are zippers, snaps, hook and loop fasteners, grommets and laces, ladder straps, magnets, clamps, hooks or other similar fastener or device for securing the cargo bag 100 to a substrate.

While the cargo bag 100 is depicted and discussed herein primarily for use on car roofs, it should be understood that the cargo bag 100 can be used with any suitable substrate. For example, the cargo bag 100 as described herein can be on/with a variety of vehicles/substrates including recreational vehicles (RVs), boats, or even be used as waterproof storage suctioned cupped to the glass on the outside of a Condo. A user could keep their chair cushions in the cargo bag 100 if they don't have an outside closet or other storage location.

Changes can be made in the above constructions without departing from the scope of the disclosure. It is intended that all matter contained in the above description or shown in the accompanying drawings shall be interpreted as illustrative and not in a limiting sense.

1-20. (canceled)

21. A cargo carrier comprising:
a base that is securable to a surface of a substrate by an attachment feature connected to the base;
the attachment feature comprising a rod that is wrapped in a material extending from the base: and
a clamp that is securable to the surface of the substrate, the clamp having an opening that is adapted and configured to receive the rod wrapped in the material extending from the base in the opening and secure the base to the surface of the substrate.

22. The cargo carrier of claim 21, further comprising:
the base being adapted and configured for engaging on the surface of the substrate and conforming to the surface of the substrate to spread a load supported on the base over the surface of the substrate.

23. The cargo carrier of claim 21, further comprising:
the rod wrapped in the material extending from the base forming a keder strip extending from the base.

24. The cargo carrier of claim 21, further comprising:
the surface of a substrate being a surface of a vehicle.

25. The cargo carrier of claim 21, further comprising:
the rod being one rod of a plurality of rods that are wrapped in the material extending from the base.

26. The cargo carrier of claim 25, further comprising:
the clamp being one clamp of a plurality of clamps that are securable to the surface of the substrate, each clamp of the plurality of clamps having an opening that is adapted and configured to receive a rod of the plurality of rods that are wrapped in the material extending from the base.

27. The cargo carrier of claim 25, further comprising:
the plurality of rods wrapped in the material extending from the base forming a plurality of keder strips extending from the base.

28. The cargo carrier of claim 21, further comprising:
the clamp having a top portion and a bottom portion with an opening between the top portion and the bottom portion; and
the opening is adapted and configured to receive the rod wrapped in the material extending from the base in the opening with the top portion and the bottom portion of the clamp securing the rod wrapped in the material extending from the base between the top potion and the bottom portion.

29. The cargo carrier of claim 28, further comprising:
the opening between the top portion and the bottom portion of the clamp is configured to receive the rod wrapped in the material extending from the base in the opening and in surface engagement between the top portion and the bottom portion of the clamp.

30. The cargo carrier of claim 28, further comprising:
the top portion and the bottom portion of the clamp being connected by a pivot connection that enables pivoting movement of the top portion and the bottom portion toward and away from each other.

31. The cargo carrier of claim 21, further comprising:
a vacuum device cup on the clamp, the vacuum device cup being adapted and configured to secure to the surface of the substrate by suction and secure the clamp to the surface of the substrate.

32. The cargo carrier of claim 31, further comprising:
the vacuum device cup being a suction cup; and
the clamp being connected to a top of the suction cup.

33. The cargo carrier of claim 21, further comprising:
the base is an inflatable pad of drop stitch construction.

34. The cargo carrier of claim 21, further comprising:
a separating zipper on the base, the separating zipper extending around the base; and
a top section that is attachable to the base by the separating zipper.

35. The cargo carrier of claim 34, further comprising:
the top section is one top section of a plurality of top sections, the plurality of top sections having different configurations and each top section of the plurality of top sections being adapted and configured for attachment to the base by the separating zipper.

36. The cargo carrier of claim 21, further comprising:
the rod is a first rod of first and second rods wrapped in the material extending from the base;
a spacing between the first rod wrapped in the material extending from the base and the second rod wrapped in the material extending from the base, the spacing enabling folding the material extending from the base across the spacing between the first rod wrapped in the material extending from the base and the second rod wrapped in the material extending from the base.

37. The cargo carrier of claim 21, further comprising:
the base having a leading edge;
a rod wrapped in the material extending from the base positioned along the leading edge of the base;
the base having a trailing edge, the trailing edge being opposite the leading edge; and
a rod wrapped in the material extending from the base positioned along the trailing edge of the base.

38. The cargo carrier of claim 37, further comprising:
the base having a first side edge;
a rod wrapped in the material extending from the base positioned along the first side edge of the base;
the base having a second side edge, the second side edge being opposite the first side edge; and
a rod wrapped in the material extending from the base positioned along the second side edge of the base.

39. The cargo carrier of claim 21, further comprising:
the base is constructed of a fabric; and
the rod is wrapped in the fabric extending from the base.

40. The cargo carrier of claim 21, further comprising:
the rod is a rigid rod having a straight length.
